(19) United States
(12) Patent Application Publication
(10) Pub. No.: US 2008/0130115 A1
(43) Pub. Date: Jun. 5, 2008

(54) OPTICAL PLATE HAVING THREE LAYERS

(75) Inventors: TUNG-MING HSU, Tu-Cheng (TW); SHAO-HAN CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/627,579

(22) Filed: Jan. 26, 2007

(30) Foreign Application Priority Data
Dec. 1, 2006 (CN) 200610201177.3

(51) Int. Cl. G02B 5/02

(52) U.S. Cl. 359/599; 359/831

(57) ABSTRACT

An exemplary optical plate includes a first transparent layer (21), a second transparent layer (23) and a light diffusion layer (22). The first transparent layer includes an outer surface (210) and a plurality of spherical protrusions (211) protruding out from the outer surface. The second transparent layer includes an outer surface (230) and a plurality of conical frustum protrusions (231) protruding out from the outer surface. The first transparent, the light diffusion layer, and the second transparent are integrally formed, with the first transparent layer in immediate contact with the light diffusion layer, and the second transparent layer in immediate contact with the light diffusion layer. The light diffusion layer includes a transparent matrix resin (221) and a plurality of diffusion particles (222) dispersed in the transparent matrix resin.

### CROSS-REFERENCE TO RELATED APPLICATIONS

This application is related to U.S. patent application Ser. No. 11/620,951 filed on Jan. 8, 2006 and entitled “OPTICAL PLATE HAVING THREE LAYERS” and U.S. patent application Ser. No. 11/620,958 filed on Jan. 8, 2006 and entitled “OPTICAL PLATE HAVING THREE LAYERS AND MICRO PROTRUSIONS”, both of which have the same applicant and assignee as the present invention.

### BACKGROUND OF THE INVENTION

1. Field of the Invention

The present invention generally relates to optical plates, and more particularly, to an optical plate for use in, for example, a liquid crystal display (LCD).

2. Discussion of the Related Art

The lightness and slimness of LCD panels make them suitable for a wide variety of uses in electronic devices such as personal digital assistants (PDAs), mobile phones, portable personal computers, and other electronic appliances. Liquid crystal is a substance that cannot by itself emit light; instead, the liquid crystal relies on receiving light from a light source in order to display images and data. In the case of a typical LCD panel, a backlight module powered by electricity supplies the needed light.

FIG. 8 is an exploded, side cross-sectional view of a typical backlight module 10 employing a typical optical diffusion plate. The backlight module 10 includes a housing 11, a plurality of lamps 12 disposed on a base of the housing 11, and a light diffusion plate 13 and a prism sheet 15 stacked on the housing 11 in that order. The lamps 12 emit light rays, and inside walls of the housing 11 are configured for reflecting some of the light rays upwards. The light diffusion plate 13 includes a plurality of dispersion particles. The dispersion particles are configured for scattering received light rays and thereby enhancing the uniformity of light rays that exit the light diffusion plate 13. The prism sheet 15 includes a plurality of V-shaped structures on a top thereof. The V-shaped structures are configured for collimating received light rays to a certain extent.

In use, the light rays from the lamps 12 enter the prism sheet 15 after being scattered in the diffusion plate 13. The light rays are refracted by the V-shaped structures of the prism sheet 15, and are thereby concentrated so as to increase brightness of light illumination. Finally, the light rays propagate into an LCD panel (not shown) disposed above the prism sheet 15. Even though the diffusion plate 13 and the prism sheet 15 are in contact with each other, a plurality of air pockets still exists at the boundary therebetween. When the backlight module 10 is in use, light passes through the air pockets, and some of the light undergoes total reflection at one or another of the corresponding boundaries. As a result, the light energy utilization ratio of the backlight module 10 is reduced.

Therefore, a new optical means is desired in order to overcome the above-described shortcomings.

### SUMMARY

An optical plate includes a first transparent layer, a second transparent layer, and a light diffusion layer. The light diffusion layer is between the first transparent layer and the second transparent layer. The light diffusion layer includes a transparent matrix resin and a plurality of diffusion particles dispersed in the transparent matrix resin. The first transparent layer, the light diffusion layer, and the second transparent layer are integrally formed, with the first transparent layer in immediate contact with the light diffusion layer, and the second transparent layer in immediate contact with the light diffusion layer. The first transparent layer forms a plurality of spherical protrusions protruding from an outer surface thereof distalmost from the light diffusion layer. The second transparent layer forms a plurality of conical frustum protrusions protruding out from an outer surface thereof distalmost from the light diffusion layer.

Other novel features will become more apparent from the following detailed description, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical plate. Moreover, in the drawings, like reference numerals designate corresponding parts throughout the several views, and all the views are schematic.

FIG. 1 is an isometric view of an optical plate in accordance with a first embodiment of the present invention.

FIG. 2 is an isometric, inverted view of the optical plate of FIG. 1.

FIG. 3 is a cross-sectional view of the optical plate of FIG. 1, taken along line III-III thereof.

FIG. 4 is a top plan view of the optical plate of FIG. 1.

FIG. 5 is a top plan view of an optical plate in accordance with a second embodiment of the present invention.

FIG. 6 is a top plan view of an optical plate in accordance with a third embodiment of the present invention.

FIG. 7 is a side cross-sectional view of an optical plate in accordance with a fourth embodiment of the present invention.

FIG. 8 is an exploded, side cross-sectional view of a conventional backlight module.

### DETAILED DESCRIPTION OF THE EMBODIMENTS

Reference will now be made to the drawings to describe preferred embodiments of the present optical plate, in detail.

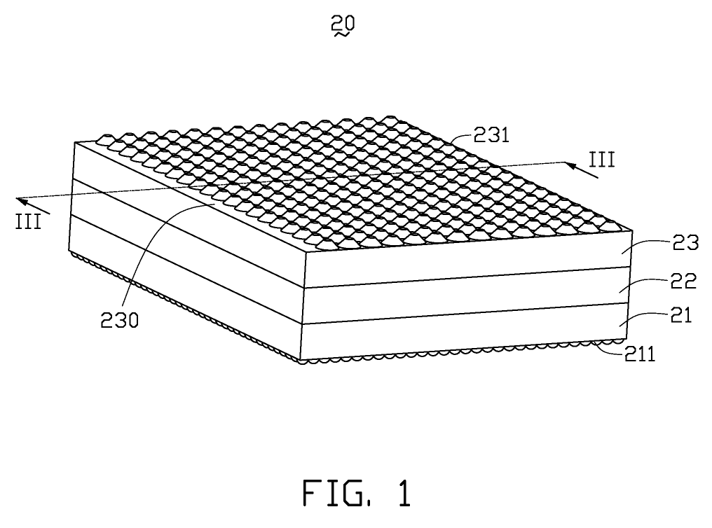

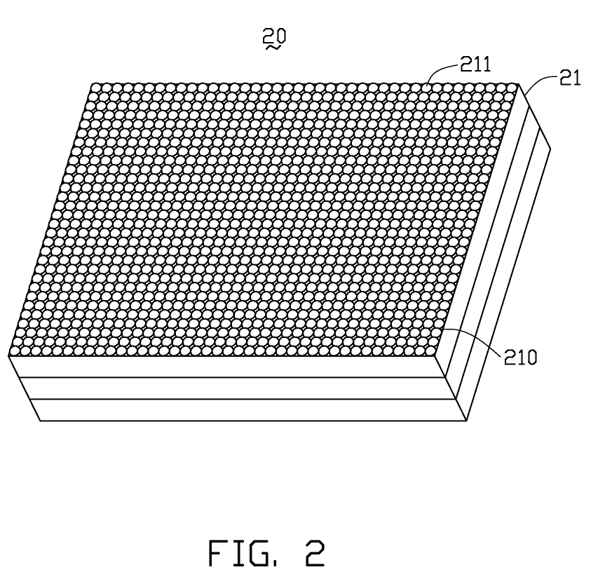

Referring to FIGS. 1 to 3, an optical plate 20 according to a first embodiment is shown. The optical plate 20 includes a first transparent layer 21, a light diffusion layer 22, and a second transparent layer 23. The first transparent layer 21, the light diffusion layer 22 and the second transparent layer 23 are integrally formed, with the light diffusion layer 22 being between the first transparent layer 21 and the second transparent layer 23. The first transparent layer 21 and the light diffusion layer 22 are in immediate contact with each other at a common interface thereof. Similarly, the second transparent layer 23 and the light diffusion layer 22 are in immediate contact with each other at a common interface thereof. This kind of unified body with no gaps in the common interfaces can be made by a multi-shot injection mold. The first transparent layer 21 has a plurality of spherical protrusions 211 protruding out from an outer surface 210 thereof distalmost from the light diffusion layer 22. The second transparent layer 23 has a plurality of conical frustum protrusions 231 protruding out from an outer surface 230 thereof distalmost from the light diffusion layer 22.

A thickness of each of the first transparent layer 21, the light diffusion layer 22, and the second transparent layer 23 may be greater than or equal to 0.35 millimeters (mm). In a preferred embodiment, a combined thickness of the first transparent layer 21, the light diffusion layer 22, and the second transparent layer 23 is in the range from about 1.05 mm to about 6 mm. The first and second transparent layers 21, 23 can be made of transparent matrix resin selected from the group including polyacrylic acid (PAA), polycarbonate (PC), polystyrene (PS), polymethyl methacrylate (PMMA), methylmethacrylate and styrene (MS), and any suitable combination thereof. It should be noted that the material of the first and second transparent layers 21, 23 may be the same or may be different.

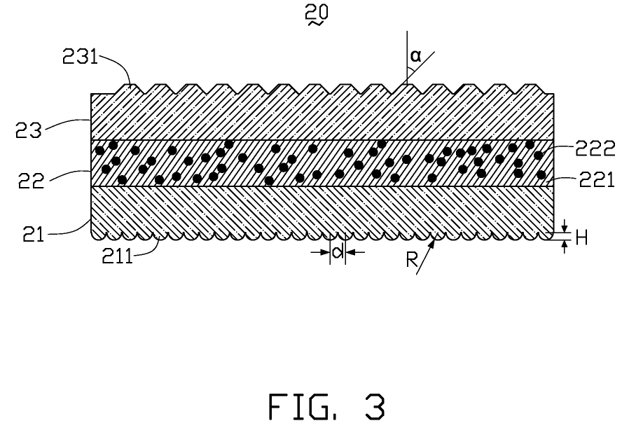

Referring to FIG. 3, in this embodiment, each spherical protrusion 211 is substantially a hemisphere. The spherical protrusions 211 are arranged regularly on the outer surface 210, thus forming a matrix. A pitch d between two adjacent spherical protrusions 211 is in the range from about 0.025 mm to about 1.5 mm. A radius R of each of the spherical protrusions 211 is in the range from about a quarter of the pitch d to about twice the pitch d. A height H of each of the spherical protrusions 211 is in the range from about 0.01 mm to the radius R. It should be understood that each spherical protrusion 211 can instead be replaced by a protrusion smaller than a hemisphere. That is, each spherical protrusion 211 can instead be a sub-hemispherical protrusion.

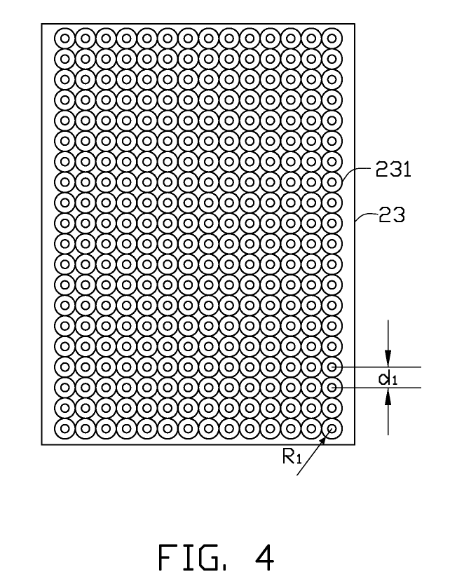

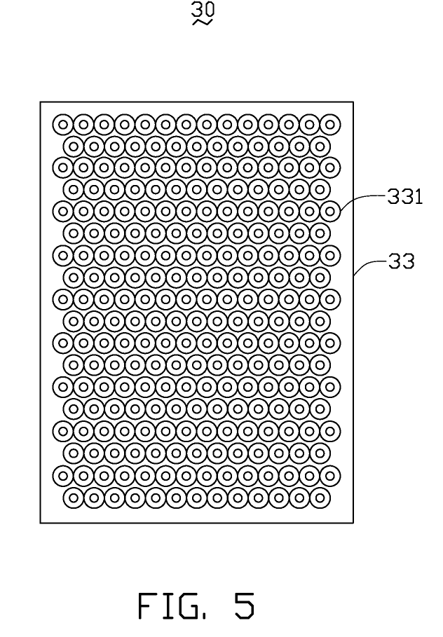

Also referring to FIG. 4, the conical frustum protrusions 231 are arranged regularly on the outer surface 230, thus forming a matrix. Each conical frustum protrusion 231 abuts all four adjacent conical frustum protrusions 231. A horizontal width of each conical frustum protrusion 231 increases from a top end of the conical frustum protrusion 231 to a bottom end of the conical frustum protrusion 231. Thus a cross-section taken along an axis of symmetry of the conical frustum protrusion 231 defines an isosceles trapezium. A pitch d₁ between two adjacent conical frustum protrusions 231 is preferably in the range from about 0.025 mm to about 1.5 mm. A maximum radius R₁ of each of the conical frustum protrusions 231 is preferably in the range from about a quarter of the pitch d₁ to about the pitch d₁. An angle α defined by a side surface of each conical frustum protrusion 231 relative to a central axis of the conical frustum protrusion 231 is preferably in the range from about 30 degrees to about 75 degrees.

The light diffusion layer 22 includes a transparent matrix resin 221, and a plurality of diffusion particles 222 dispersed in the transparent matrix resin 221. The transparent matrix resin 221 can be made of material selected from the group including polyacrylic acid (PAA), polycarbonate (PC), polystyrene (PS), polymethyl methacrylate (PMMA), methylmethacrylate and styrene (MS), and any suitable combination thereof. The diffusion particles 222 can be made of material selected from the group including titanium dioxide, silicon dioxide, acrylic resin, and any suitable combination thereof. The diffusion particles 222 are configured for scattering light rays and enhancing the uniformity of light exiting the light diffusion layer 22. The light diffusion layer 22 preferably has a light transmission ratio in a range from 30% to 98%. The light transmission ratio of the light diffusion layer 22 is determined by a composition of the transparent matrix resin 221 and the diffusion particles 222.

It should be noted that when the optical plate 20 is used in a direct type backlight module, either the first transparent layer 21 or the second transparent layer 23 of the optical plate 20 can be arranged to face a light source of the backlight module. Light rays from the light source directly enter the optical plate 20 via the first transparent layer 21 or the second transparent layer 23.

When the light rays enter the optical plate 20 via the first transparent layer 21, the light rays are diffused by the spherical protrusions 211 of the first transparent layer 21. Then the light rays are substantially further diffused in the light diffusion layer 22 of the optical plate 20. Finally, many or most of the light rays are condensed by the conical frustum protrusions 231 of the second transparent layer 23 before they exit the optical plate 20. As a result, a brightness of the backlight module can be increased. In addition, the light rays are diffused at two levels within the optical plate 20, so that a uniformity of light output from the optical plate 20 is enhanced. Furthermore, the first transparent layer 21, the light diffusion layer 22, and the second transparent layer 23 are integrally formed together (see above), with no air or gas pockets at the respective interfaces therebetween. Thus the efficiency of utilization of light rays is increased. Moreover, when the optical plate 20 is utilized in a backlight module, the optical plate 20 in effect replaces the conventional combination of a diffusion plate and a prism sheet. Therefore compared with conventional art, a process of assembly of the backlight module is simplified and the efficiency of assembly is improved. Still further, in general, a space occupied by the optical plate 20 is less than that occupied by the conventional combination of a diffusion plate and a prism sheet. Thus a size of the backlight module can also be reduced.

When the light rays enter the optical plate 20 via the second transparent layer 23, a uniformity of light output from the optical plate 20 is also enhanced, and the efficiency of utilization of light rays is also increased. Nevertheless, the light rays emitted from the optical plate 20 via the first transparent layer 21 are different from the light rays emitted from the optical plate 20 via the second transparent layer 23. For example, when the light rays enter the optical plate 20 via the first transparent layer 21, a viewing angle of a liquid crystal display device using the backlight module is somewhat larger than that of the liquid crystal display device when the light rays enter the optical plate 20 of the backlight module via the second transparent layer 23.

Referring to FIG. 5, an optical plate 30 according to a second embodiment is shown. The optical plate 30 includes a second transparent layer 33 and a plurality of conical frustum protrusions 331. The conical frustum protrusions 331 are formed on the second transparent layer 33 in a series of rows. The conical frustum protrusions 331 in a same row abut one another. The conical frustum protrusions 331 in each row are staggered relative to the conical frustum protrusions 331 in each of the two adjacent rows. Thus a matrix comprised of offset rows of the conical frustum protrusions 331 is formed. Each conical frustum protrusion 331 is spaced apart from the adjacent conical frustum protrusions 331 in each adjacent row.

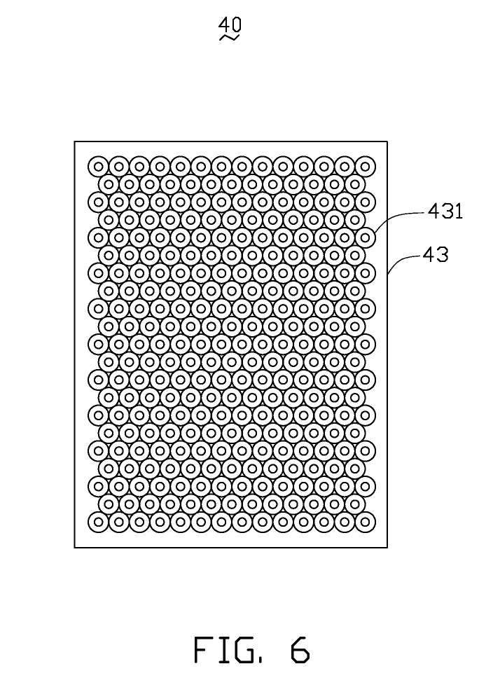

Referring to FIG. 6, an optical plate 40 according to a third embodiment is shown. The optical plate 40 includes a second transparent layer 43 and a plurality of conical frustum protrusions 431. The conical frustum protrusions 431 are formed on the second transparent layer 43, and are arranged in staggered rows in similar fashion to the conical frustum protrusions 331 of the optical plate 30. However, the staggered rows are arranged so that they abut each other. Thus a honeycomb pattern of the conical frustum protrusions 431 is formed. Each conical frustum protrusion 431 abuts the adjacent conical frustum protrusions 431 in each adjacent row.

It should be understood that the conical frustum protrusions 231, 331, 431 of the optical plates 20, 30, 40 are not limited to being arranged in a regular matrix. The conical frustum protrusions 231, 331, 431 can alternatively be arranged otherwise. In alternative arrangements, a pitch between any two adjacent conical frustum protrusions 231, 331, 431 is preferred to be uniform. In another example, the conical frustum protrusions 231, 331, 431 can be arranged randomly. Similarly, the spherical protrusions 211 of the optical plate 20 are not limited to being arranged in a regular matrix. The spherical protrusions 211 can alternatively be arranged otherwise. For example, the spherical protrusions 211 in each of rows can be staggered relative to the spherical protrusions 211 in each of two adjacent rows, with each spherical protrusion 211 in each row being spaced apart from the adjacent spherical protrusions 211 in each adjacent row. In another example, the spherical protrusions 211 can be arranged in a honeycomb pattern.

In the optical plate 20 of the first embodiment, an interface between the light diffusion layer 22 and the first transparent layer 21 is flat. Similarly, an interface between the light diffusion layer 22 and the second transparent layer 23 is flat. Alternatively, the interface between the light diffusion layer 22 and the first transparent layer 21 may be non-planar. Similarly, the interface between the light diffusion layer 22 and the second transparent layer 23 may be non-planar. Examples of such non-planar interfaces include curved interfaces such as wavy interfaces. In these kinds of alternative embodiments, a binding strength between the light diffusion layer 22 and the first transparent layer 21 can be increased. Similarly, a binding strength between the light diffusion layer 22 and the second transparent layer 23 can be increased.

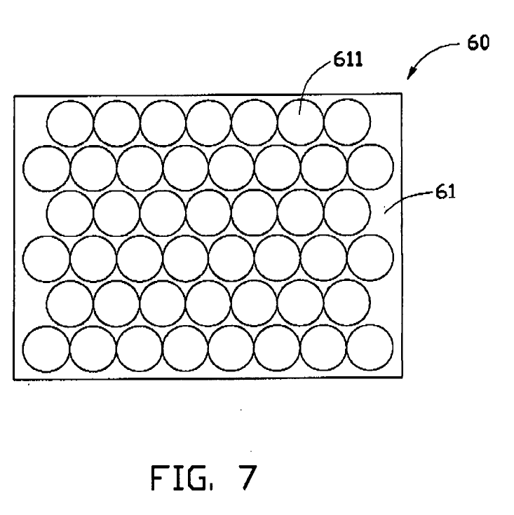

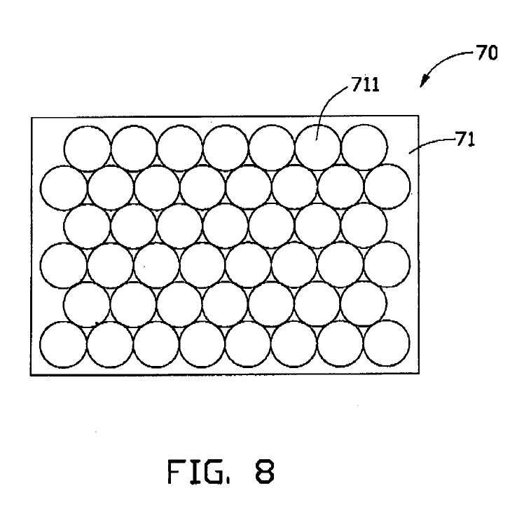

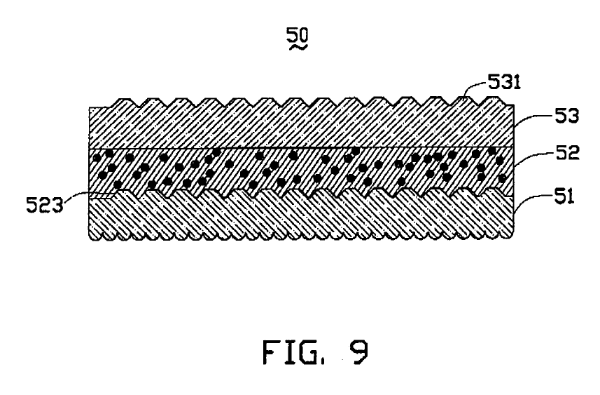

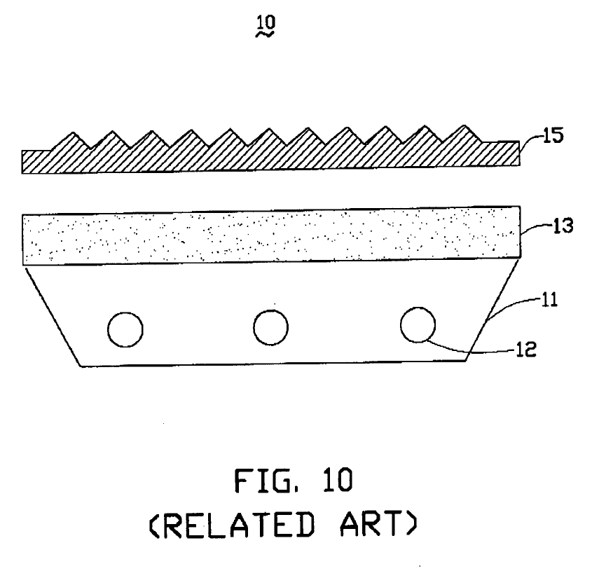

For example, referring to FIG. 7, an optical plate 50 in accordance with a fourth embodiment is shown. The optical plate 50 is similar to the optical plate 20 of the first embodiment. However, the optical plate 50 includes a first transparent layer 51, a light diffusion layer 52, and a second transparent layer 53. The light diffusion layer 52 defines a plurality of recesses 523 at an interface thereof that adjoins the first transparent layer 51. The recesses 523 are conical frustum shaped. Alternatively, the recesses 523 may be hemispherical or sub-hemispherical. In another alternative embodiment, the recesses 523 may be provided in the first transparent layer 51 instead of in the light diffusion layer 52. In further or alternative embodiments, an interface between the light diffusion layer 52 and the second transparent layer 53 may be non-planar. Such interface can for example be curved. Alternatively, a plurality of conical frustum shaped recesses, hemispherical recesses, or sub-hemispherical recesses may be provided at such interface.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. An optical plate, comprising:
a first transparent layer;
a second transparent layer; and
a light diffusion layer between the first transparent layer and the second transparent layer, the light diffusion layer including a transparent matrix resin and a plurality of diffusion particles dispersed in the transparent matrix resin;
wherein the first transparent layer, the light diffusion layer, and the second transparent layer are integrally molded together, with the first transparent layer in immediate contact with the light diffusion layer, and the second transparent layer in immediate contact with the light diffusion layer such that there are no air or gas pockets trapped between the first transparent layer and the light diffusion layer nor between the second transparent layer and the light diffusion layer, the first transparent layer forms a plurality of spherical protrusions protruding from an outer surface thereof farthest from the light diffusion layer, and the second transparent layer forms a plurality of conical frustum protrusions protruding out from an outer surface thereof farthest from the light diffusion layer.

2. The optical plate as claimed in claim 1, wherein a thickness of each of the light diffusion layer, the first transparent layer, and the second transparent layer is greater than or equal to 0.35 millimeters.

3. The optical plate as claimed in claim 2, wherein a combined thickness of the light diffusion layer, the first transparent layer, and the second transparent layer is in the range from about 1.05 millimeters to about 6 millimeters.

4. The optical plate as claimed in claim 1, wherein each of the first and second transparent layers is made of material selected from the group consisting of polyacrylic acid, polycarbonate, polystyrene, polymethyl methacrylate, methylmethacrylate and styrene, and any combination thereof.

5. The optical plate as claimed in claim 1, wherein a pitch between centre points of two adjacent spherical protrusions is in the range from about 0.025 millimeters to about 1.5 millimeters.

6. The optical plate as claimed in claim 5, wherein a radius of each of the spherical protrusions is in die range from about a quarter of the pitch between two adjacent spherical protrusions to about twice the pitch, and a height of each spherical protrusion is in the range from about 0.01 millimeters to the radius of the spherical protrusions.

7. The optical plate as claimed in claim 1, wherein the spherical protrusions are arranged on the outer surface of the first transparent layer in a regular matrix.

8. The optical plate as claimed in claim 1, wherein the spherical protrusions are arranged on the outer surface of the first transparent layer in rows, and the spherical protrusions in each row are staggered relative to the spherical protrusions in each of the two adjacent rows.

9. The optical plate as claimed in claim 1, wherein the spherical protrusions are arranged on the outer surface of the first transparent layer in a honeycomb pattern.

10. The optical plate as claimed in claim 1, wherein a pitch between axes of two adjacent conical frustum protrusions is in the range from about 0.025 mm to about 1.5 mm.

11. The optical plate as claimed in claim 10, wherein a maximum radius of each conical frustum protrusion is in the range from about a quarter of the pitch between two adjacent conical frustum protrusions to about the pitch between two adjacent conical frustum protrusions, and an angle defined by a side surface of each conical frustum protrusion relative to a central axis of the conical frustum protrusion is in the range from about 30 degrees to about 75 degrees.

12. The optical plate as claimed in claim 1, wherein the conical frustum protrusions are arranged on the outer surface of the second transparent layer in a regular matrix.

13. The optical plate as claimed in claim 1, wherein the conical frustum protrusions are arranged on the outer surface of the second transparent layer in rows, and the conical frustum protrusions in each row are staggered relative to the conical frustum protrusions in each of the two adjacent rows.

14. The optical plate as claimed in claim 1, wherein the conical frustum protrusions are arranged on the outer surface of the second transparent layer in a honeycomb pattern.

15. The optical plate as claimed in claim 1, wherein at least one of the following interfaces is flat: an interface between the light diffusion layer and the first transparent layer, and an interface between the light diffusion layer and the second transparent layer.

16. The optical plate as claimed in claim 1, wherein at least one of the following interfaces is non-planar: an interface between the light diffusion layer and the first transparent layer, and an interface between the light diffusion layer and the second transparent layer.

17. The optical plate as claimed in claim 16, wherein the light diffusion layer defines a plurality of conical frustum shaped recesses at the interface between the light diffusion ion layer and the first transparent layer.

18. The optical plate as claimed in claim 1, wherein the transparent matrix resin of the diffusion layer is made of material selected from the group consisting of polyacrylic acid, polycarbonate, polystyrene, polymethyl methacrylate, methylmethacrylate and styrene (MS), and any combination thereof.

19. The optical plate as claimed in claim 1, wherein a material of the diffusion particles is selected from the group consisting of titanium dioxide, silicon dioxide, acrylic resin, and any combination thereof.

20. An optical plate, comprising:
a first transparent layer;
a second transparent layer; and
a light diffusion layer between the first and second transparent layers, the light diffusion layer being integrally molded together with the first and second transparent layers, with the light diffusion layer and the first transparent layer gaplessly in contact with each other, and the light diffusion layer and the second transparent layer gaplessly in contact with each other such that there are no air or gas pockets trapped between the light diffusion layer and the first transparent layer nor between the light diffusion layer and the second transparent layer, the light diffusion layer comprising a transparent matrix resin and a plurality of diffusion particles dispersed in the transparent matrix resin;
wherein the first transparent layer includes a plurality of spherical protrusions at an outer surface thereof farthest from the second transparent layer, and the second transparent layer includes a plurality of conical frustum protrusions at an outer surface thereof farthest from the first transparent layer.
